(19) United States
(12) Patent Application Publication
(10) Pub. No.: US 2023/0089402 A1
(43) Pub. Date: Mar. 23, 2023

(54) METHOD FOR PRODUCTION OF A FUEL CELL, DEVICE FOR PRODUCTION OF A MEMBRANE ELECTRODE ASSEMBLY FOR A FUEL CELL, FUEL CELL AND FUEL CELL STACK

(71) Applicants: AUDI AG, Ingolstadt (DE); VOLKSWAGEN AG, Wolfsburg (DE)

(72) Inventors: Gerold HÜBNER, Braunschweig (DE); Hannes SCHOLZ, Isenbüttel (DE)

(21) Appl. No.: 17/909,304

(22) PCT Filed: Dec. 15, 2020
(86) PCT No.: PCT/EP2020/086150

§ 371 Date: Sep. 2, 2022

(30) Foreign Application Priority Data
Mar. 6, 2020 (DE) 10 2020 106 082.3

(51) Int. Cl. H01M 4/88; H01M 4/86; H01M 8/1004; H01M 8/0258

(52) U.S. Cl. CPC H01M 4/881; H01M 4/861; H01M 4/8636; H01M 4/8642; H01M 4/8828; H01M 4/8882; H01M 4/8896; H01M 8/1004; H01M 8/0258; H01M 2008/1095

(57) ABSTRACT

A method for production of a fuel cell includes:

a) Preparing a plurality of catalyst pastes which differ from each other at least in regard to one parameter influencing the catalytic activity,

b) Filling of at least two of the plurality of catalyst pastes into a first application means having a number of chambers corresponding to the number of catalyst pastes being filled, where only one of the catalyst pastes is filled into each of the chambers,

c) Filling of at least two of the plurality of catalyst pastes into a second application means having a number of chambers corresponding to the number of catalyst pastes being filled, where only one of the catalyst pastes is filled into each of the chambers,

d) Coating of a first side of a foil web of an electrolyte membrane which is moved past the first application means and the second application means by means of the first application means,

e) Coating of a second side of the foil web by means of the second application means,

f) Cutting of the resulting coated electrolyte membrane from the foil web and rotating of the electrolyte membrane by 90° with respect to a delivery direction of the foil web,

g) Placing of the electrolyte membrane between two flow field plates with a gradient in regard to the parameter which is oriented perpendicular to the flow field, and

h) Pressing together the flow field plates.

### BACKGROUND

### Technical Field

Embodiments of the invention relate to a method for production of a fuel cell.

Embodiments of the invention furthermore relate to a device for the production of a membrane electrode assembly for a fuel cell, a fuel cell, and a fuel cell stack.

### Description of the Related Art

Fuel cell devices are used for the chemical transformation of a fuel with oxygen to form water, in order to generate electrical energy. For this, fuel cells contain as their core component an electrolyte and associated electrodes. In the operation of the fuel cell device having a plurality of fuel cells assembled into a fuel cell stack, the fuel, especially hydrogen (H₂) or a hydrogen-containing gas mixture is supplied to the anode. In the case of a hydrogen-containing gas, the gas is at first reformed, thus providing hydrogen. At the anode, an electrochemical of H₂ to H⁺ occurs, giving off electrons. The electrons provided at the anode are taken by an electrical conduit to the cathode. The cathode is supplied with oxygen or an oxygen-containing gas mixture, so that a reduction of O₂ to O²⁻ occurs, taking up the electrons.

In the case of solid oxide fuel cells, the electrolyte consists of a solid ceramic material, which is capable of conducting oxygen ions, yet acts as an insulator for electrons. For these solid oxide fuel cells the operating temperatures lie between 650° C. and 1000° C. In polymer electrolyte membrane (PEM) fuel cells, the electrolyte consists of a solid polymer membrane, such as one known by the brand name Nafion. PEM fuel cells have a distinctly lower operating temperature and are used preferably in mobile applications without utilization of the waste heat.

In EP 2 660 918 A2 a solid oxide fuel cell is described which utilizes hydrocarbons such as methane as the fuel, being first reformed to produce hydrogen. This results in a large temperature difference within the solid oxide fuel cell, impairing its mechanical and chemical durability. In order to mitigate this, the use of a graduated electrode is proposed, in which a catalyst sheet is employed having gradually changing catalyst content. The catalyst sheet is fabricated such that a plurality of regions having different catalyst content is formed, so that a gradient in terms of catalyst content is provided in the flow direction of the fuel, in order to lessen the temperature differences. For this, a transfer foil is coated by means of a lengthwise slotted nozzle having multiple chambers, which serve to hold different catalyst pastes. The solid oxide fuel cell itself is fabricated by forming a layering from separately fabricated sheets, namely, an electrolyte sheet, a functional layer sheet, a support layer sheet and the catalyst sheet, and this is then subjected to a sinter process.

DE 10 2016 224 398 A1 describes a device for production of a membrane electrode assembly for a PEM fuel cell, in which an electrolyte membrane is unwound and fed to a transfer section by an electrolyte feeding device, wherein on one side of the electrolyte membrane there is applied a homogeneous catalyst coating with a first catalyst coating device and on the other side of the electrolyte membrane there is applied a homogeneous catalyst coating with a second catalyst coating device. In DE 10 2007 014 046 A1 there is described a fuel cell in which neighboring regions are formed with different diffusion transport for educts and products.

Thus far, only electrodes for fuel cells composed of homogeneous electrode layers can be manufactured on an industrial scale. Yet it may be advantageous for the operation of fuel cells when the electrodes have a gradient in terms of a property in the flow direction dictated by the flow field parallel to the orientation of the membrane, i.e., when the electrodes are not homogeneous, but graduated. Properties of the electrodes are, for example, their catalytic activity, hydrophobicity, surface size, porosity, and the like. By a graduated property is meant a graduated distribution of one of the above indicated properties, which are determined by the following presented parameters for the graduated electrode.

### BRIEF SUMMARY

Some embodiments provide a method which can be used on an industrial scale for the production of a fuel cell having a graduated electrode. A device for the production of a membrane electrode assembly having a graduated electrode, an improved fuel cell, and an improved fuel cell stack are also provided.

Some embodiments relate to a method for production of a fuel cell, involving the steps:
a) preparing a plurality of catalyst pastes which differ from each other at least in regard to one parameter influencing the catalytic activity;
b) filling of at least two of the plurality of catalyst pastes into a first application tool having a number of chambers corresponding to the number of catalyst pastes being filled, where only one of the catalyst pastes is filled into each of the chambers;
c) filling of at least two of the plurality of catalyst pastes into a second application tool having a number of chambers corresponding to the number of catalyst pastes being filled, where only one of the catalyst pastes is filled into each of the chambers;
d) coating of a first side of a foil web of an electrolyte membrane which is moved past the first application tool and the second application tool by means of the first application tool;
e) coating of a second side of the foil web by means of the second application tool;
f) cutting of the resulting coated electrolyte membrane from the foil web and rotating of the electrolyte membrane by 90° with respect to a delivery direction of the foil web;
g) placing of the electrolyte membrane between two flow field plates with a gradient in regard to the parameter which is oriented perpendicular to the flow field; and
h) pressing together the flow field plates.

The term catalytic property should be interpreted broadly here and also includes the time behavior, the stability of the electrodes, and/or their tendency to supply reactant and drain reactant, especially the porosity. The catalyst pastes differ in their ingredients and additives, which in the dried state result in electrode webs having the corresponding properties.

The aforementioned method is characterized in that a large variability is achieved in regard to the properties of the electrodes of a membrane electrode assembly, in particular it is possible to adapt the cathode layer for an electrode applied to the electrolyte membrane especially in terms of its properties along the associated flow field in its flow direction. The other electrode can have a conventional design, i.e., without a property gradient, or it can also be graduated. The membrane electrode assembly so fabricated is cut out and the cutout is rotated so that the gradient is in the desired orientation along the flow field of the flow field plates. The gradient can be increasing or decreasing.

The possibility exists of varying the catalytic property in a broad range in that the catalytic parameter is chosen from a group encompassing the catalyst type, the catalyst load, the catalyst substrate type, the ionomer type, the ionomer concentration, the porosity. It should be pointed out that more than one parameter can be varied according to the above mentioned method.

It is proposed that the catalyst pastes applied to the foil web on one side touch each other at the margin, since this affords the possibility of the catalyst pastes mixing in the margin regions and thus the difference between the catalyst pastes is partly equalized, i.e., there is no graduation in terms of catalytic activity.

In order not to mechanically overstrain the electrolyte membrane during the coating with the catalyst layer, it is proposed that steps d) and e) are performed in succession.

Prior to step f), i.e., the cutting out of the electrolyte membrane, a drying step can be performed, in order to make possible and facilitate the further processing of the membrane electrode assembly.

The application means may be a slotted nozzle or a doctor blade, since these means have proven themselves for industrial coating methods with moving webs or foils.

A device for production of a membrane electrode assembly for a fuel cell according to the aforementioned methods comprises an electrolyte membrane feeding device by which an electrolyte membrane can be unwound from a supply roll and fed to a web path, where a first application means having a plurality of chambers is arranged on a first side of the web path and a second application means having a plurality of chambers is arranged on a second side of the web path, as well as a drying unit situated downstream from the first application means and the second application means.

A fuel cell produced according to the aforementioned method is optimized in terms of its properties and in particular possesses a greater effectiveness, and thus a greater efficiency, since the fuel utilization and the water management can be improved. This also results in a longer service life and lower costs.

In a fuel cell stack there is present a plurality of fuel cells, while at least one of the fuel cells due to its position within the fuel cell stack is provided with a plurality of catalyst pastes, at least one of which differs in regard to a parameter influencing the catalytic activity from the catalyst pastes of the other fuel cells. This fuel cell is thus optimized, but also multiple fuel cells in the fuel cell stack can be provided with a property gradient. This property gradient need not be the same for all the fuel cells, and in particular the end fuel cells may have a property gradient differing from the middle fuel cells.

The features and combinations of features mentioned above in the specification and also the features and combinations of features mentioned below in the description of the figures and/or shown only in the figures can be used not only in the particular indicated combination, but also in other combinations or standing alone, without leaving the scope of the disclosure. Thus, embodiments not explicitly shown or discussed in the figures, yet which emerge from and can be created from the explained embodiments by separate combinations of features should be seen as also being encompassed and disclosed by the present disclosure.

### BRIEF DESCRIPTION OF THE SEVERAL VIEWS OF THE DRAWINGS

Further benefits, features and details will emerge from the claims, the following description of embodiments, and the drawings.

FIG. 1 shows a schematic representation of a layout of a fuel cell.

FIG. 2 shows a schematic detail view II of an electrode from FIG. 1.

FIG. 3 shows a schematic representation of a device for production of a membrane electrode assembly in a side view.

FIG. 4 shows a top view of an electrolyte membrane having a plurality of catalyst pastes and coated by means of a slotted nozzle, having the property gradient in terms of catalytic activity as symbolized by the arrow.

FIG. 5 shows a top view of the cutout of the electrolyte membrane after being rotated by 90°, with the flow direction in the flow field as symbolized by the arrow.

### DETAILED DESCRIPTION

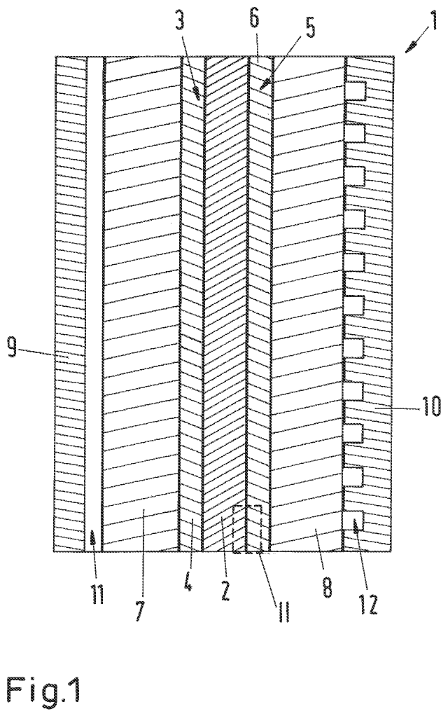

FIG. 1 shows a fuel cell 1. A semipermeable electrolyte membrane 2 here is covered on a first side 3 with a first electrode 4, in the present case the anode, and on a second side 5 with a second electrode 6, in the present case the cathode. The first electrode 4 and the second electrode 6 comprise substrate particles 14, on which catalyst particles 13 of precious metals or mixtures containing precious metals such as platinum, palladium, ruthenium or the like are arranged or substrated. These catalyst particles 13 serve as reaction accelerants in the electrochemical reaction of the fuel cell 1. The substrate particles 14 may contain carbon. Yet substrate particles 14 may also be considered which are formed from a metal oxide or carbon with an appropriate coating. In such a polymer electrolyte membrane fuel cell (PEM fuel cell), fuel or fuel molecules, especially hydrogen, are split up into protons and electrons at the first electrode 5 (anode). The electrolyte membrane 2 lets through the protons (e.g., H⁺), but is impenetrable to the electrons (e⁻). The electrolyte membrane 2 in this embodiment is formed from an ionomer, such as a sulfonated tetrafluorethylene polymer (PTFE) or a polymer of perfluorinated sulfonic acid (PFSA). At the anode, the following reaction occurs: 2H₂→4H⁺+4e⁻ (oxidation/electron surrender).

While the protons pass through the electrolyte membrane 2 to the second electrode 6 (cathode), the electrons are taken by an external circuit to the cathode or to an energy accumulator. At the cathode, a cathode gas is provided, especially oxygen or oxygen-containing air, so that the following reaction occurs here: O₂+4H⁺+4e⁻→2H₂O (reduction/electron uptake). In the present case, the electrodes 4, 6 are each associated with a gas diffusion layer 7, 8, one gas diffusion layer 7 being associated with the anode and the other gas diffusion layer 8 with the cathode. Moreover, the anode-side gas diffusion layer 7 is associated with a flow field plate, shaped as a bipolar plate 9, for supply of the fuel gas, having a fuel flow field 11. By means of the fuel flow field 11, the fuel is supplied through the gas diffusion layer 7 to the electrode 4. At the cathode side, the gas diffusion layer 8 is associated with a flow field plate having a cathode gas flow field 12, likewise shaped as bipolar plate 10, for supply of the cathode gas to the electrode 6.

It should be noted that the electrodes 4, 6 may also be present as an integral part of the gas diffusion layers 7, 8. The gas diffusion layers 7, 8 may furthermore comprise a microporous layer (MPL). The electrodes 4, 6 in the present instance are formed with a multitude of catalyst particles 13, which can be formed as nanoparticles, such as “core-shell nanoparticles”. These have the advantage of a large surface, while the precious metal or the precious metal alloy is arranged only on the surface, and a less valuable metal, such as nickel or copper, forms the core of the nanoparticle.

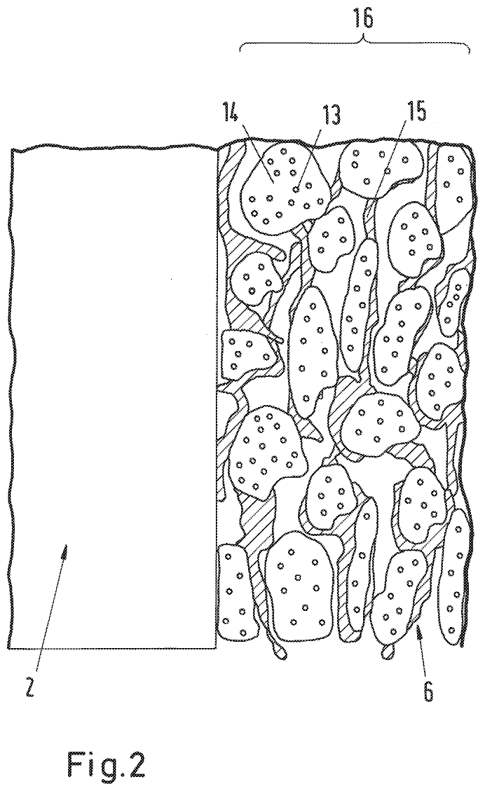

The catalyst particle 13 are arranged or substrated on a multitude of electrically conducting substrate particles 14. Furthermore, between the substrate particles 14 and/or the catalyst particles 13 there is present an ionomer binder 15, which may be formed from the same material as the membrane 2. This ionomer binder 15 may be formed as a polymer or ionomer containing a perfluorinated sulfonic acid. The ionomer binder 15 in the present case is in porous form, having a porosity of more than 30 percent. This ensures, especially on the cathode side, that the oxygen diffusion resistance is not increased, thus making possible a lower charging of the catalyst particle 13 with precious metal or a lower charging of the substrate particle 14 with catalyst particles 13 (FIG. 2).

In the following, the production of the electrodes 4, 6 will be explained. At first, the catalyst particles 13 substrated on substrate particles 14 are suspended in a solution of an ionomer binder 15. The solution of the ionomer binder 15 may contain between 15 and 25 weight-percent (wt. %), or exactly 20 wt. % of a polymer of perfluorinated sulfonic acid. Moreover, isopropanol can be added to the mixture. At the same time or afterwards, an inorganic foam forming agent is likewise suspended and a catalyst paste 16 is formed. In the method for the production of a fuel cell 1, a plurality of catalyst pastes 16 is produced, differing at least in regard to one parameter influencing the catalytic property. At least two catalyst pastes 16 from the plurality of catalyst pastes 16 are then filled into a first application means 17 having a number of chambers 18 corresponding to the number of catalyst pastes 16 being filled, only one of the catalyst pastes 16 being filled into each of the chambers 18. For example, one can employ an application means 17 configured slotted nozzle or a doctor blade, having 7 chambers, so that up to 7 different catalyst pastes 16 can be filled. A different number of catalyst pastes 16 and chambers is possible.

One proceeds in comparable manner for the second side of the electrolyte membrane 2 by filling at least two of the plurality of catalyst pastes 16 into a second application means having a number of chambers 18 corresponding to the number of catalyst pastes 16 being filled, only one of the catalyst pastes 16 being filled into each of the chambers 18. Here as well, more than two chambers 18 can be realized. It should be noted that the plurality of catalyst pastes 16 may then be as many as 14, but also partly identical catalyst pastes 16 may also be used on both sides, if necessary.

After the filling of the application means 17 comes the coating of a first side of a foil web 20 of an electrolyte membrane 2 which is moved past the first application means 17 and the second application means 17 by the first application means 17 and the coating of a second side of the foil web by the second application means 17. These steps may in theory occur simultaneously, but these steps may also be performed in succession, and afterwards the applied catalyst pastes 16 are dried with a drying unit 19 to form a catalyst layer for the electrode.

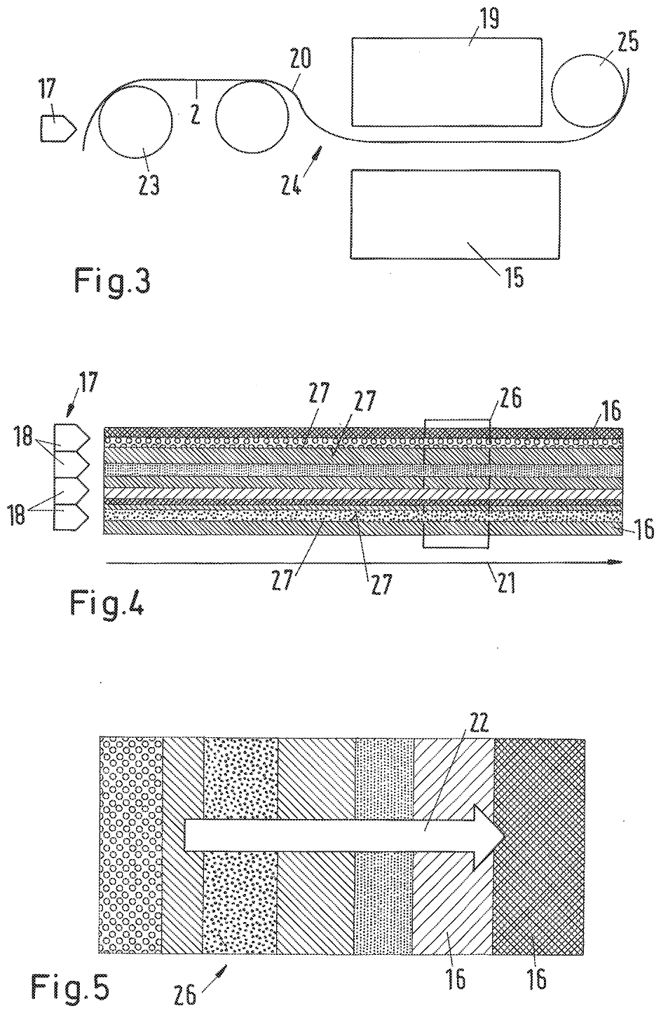

Next comes the forming of a cutout 26 of the electrolyte membrane 2 from the foil web 20 and the rotating of the electrolyte membrane 2 by 90° with respect to the delivery direction 21 of the foil web 20, in order to obtain the desired orientation of the property gradient in the flow direction 22 of the flow field, as is shown for the region indicated in FIG. 2 in the application in FIG. 3.

Next comes the placement of the electrolyte membrane 2 between two flow field plates, the bipolar plates 9, 10, with the gradient in terms of the parameter oriented perpendicular to the flow field, and the pressing of the flow field plates together.

The catalytic parameter is chosen from a group encompassing the catalyst type, the catalyst load, the catalyst substrate type, the ionomer type, the ionomer concentration, the porosity.

FIGS. 4 and 5 reveal that the catalyst pastes 16 applied to the foil web 20 on one side touch at its margin, so that the forming of a gradient instead of a graduation of the catalytic activity is encouraged.

The device shown in FIG. 3 for producing a membrane electrode assembly for a fuel cell 1 comprises an electrolyte membrane feeding device 23, by which an electrolyte membrane 2 can be unwound from a supply roll and fed to a web path 24, at which a first application means 17 having a plurality of chambers 18 is arranged on a first side of the web path 24 and a second application means 17 having a plurality of chambers 18 is arranged on a second side of the web path 24. For better clarity, only one of the application means 17 is shown. Furthermore, downstream from the first application means 17 and the second application means 17 there is arranged a drying unit 19. The electrolyte membrane 2 so processed and transformed into the membrane electrode assembly can be gathered on a coil 25 prior to further processing.

In a fuel cell stack having a plurality of fuel cells 1, at least one of the fuel cells 1 by virtue of its position within the fuel cell stack is provided with a plurality of catalyst pastes 16, at least one of which differs in regard to a parameter influencing the catalytic activity from the catalyst pastes 16 of the other fuel cells 1. This fuel cell is thus optimized, but also multiple fuel cells in the fuel cell stack can be provided with a property gradient. In particular, the end fuel cells 1 may have a property gradient differing from the middle fuel cells 1.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for production of a fuel cell, comprising:
preparing a plurality of catalyst pastes which differ from each other at least in regard to one parameter influencing catalytic activity,
filling at least two of the plurality of catalyst pastes into a first applicator having a number of chambers corresponding to the number of catalyst pastes being filled, where only one of the catalyst pastes is filled into each of the chambers,
filling at least two of the plurality of catalyst pastes into a second applicator having a number of chambers corresponding to the number of catalyst pastes being filled, where only one of the catalyst pastes is filled into each of the chambers,
coating a first side of a foil web of an electrolyte membrane which is moved past the first applicator and the second applicator by the first applicator,
coating a second side of the foil web by the second applicator,
cutting the resulting coated electrolyte membrane from the foil web and rotating the electrolyte membrane by 90° with respect to a delivery direction of the foil web,
placing the electrolyte membrane between two flow field plates with a gradient in regard to the parameter which is oriented perpendicular to the flow field, and
pressing together the flow field plates.

2. The method according to claim 1, wherein the catalytic parameter is chosen from a group encompassing the catalyst type, the catalyst load, the catalyst substrate type, the ionomer type, the ionomer concentration, the porosity.

3. The method according to claim 1, wherein the catalyst pastes applied to the foil web on one side touch each other at the margin.

4. The method according to claim 1, wherein coating of the first and second sides of the foil web are performed in succession.

5. The method according to claim 1, wherein a drying is performed prior to cutting the coated electrolyte membrane from the foil web and rotating the electrolyte membrane by 90° with respect to a delivery direction of the foil web.

6. The method according to claim 1, wherein the first and second applicators each include a slotted nozzle or a doctor blade.

7. A device for production of a membrane electrode assembly for a fuel cell, the production including: preparing a plurality of catalyst pastes which differ from each other at least in regard to one parameter influencing catalytic activity, filling at least two of the plurality of catalyst pastes into a first applicator having a number of chambers corresponding to the number of catalyst pastes being filled, where only one of the catalyst pastes is filled into each of the chambers, filling at least two of the plurality of catalyst pastes into a second applicator having a number of chambers corresponding to the number of catalyst pastes being filled, where only one of the catalyst pastes is filled into each of the chambers, coating a first side of a foil web of an electrolyte membrane which is moved past the first applicator and the second applicator by the first applicator, coating a second side of the foil web by the second applicator, cutting the resulting coated electrolyte membrane from the foil web and rotating the electrolyte membrane by 90° with respect to a delivery direction of the foil web, placing the electrolyte membrane between two flow field plates with a gradient in regard to the parameter which is oriented perpendicular to the flow field, and pressing together the flow field plates, the device comprising:
an electrolyte membrane feeding device by which an electrolyte membrane can be unwound from a supply roll and fed to a web path,
where a first applicator having a plurality of chambers arranged on a first side of the web path,
a second applicator having a plurality of chambers arranged on a second side of the web path, and
a drying unit situated downstream from the first applicator and the second applicator.

8. (canceled)

9. A fuel cell stack having a plurality of fuel cells produced according to a method including: preparing a plurality of catalyst pastes which differ from each other at least in regard to one parameter influencing catalytic activity, filling at least two of the plurality of catalyst pastes into a first applicator having a number of chambers corresponding to the number of catalyst pastes being filled, where only one of the catalyst pastes is filled into each of the chambers, filling at least two of the plurality of catalyst pastes into a second applicator having a number of chambers corresponding to the number of catalyst pastes being filled, where only one of the catalyst pastes is filled into each of the chambers, coating a first side of a foil web of an electrolyte membrane which is moved past the first applicator and the second applicator by the first applicator, coating a second side of the foil web by the second applicator, cutting the resulting coated electrolyte membrane from the foil web and rotating the electrolyte membrane by 90° with respect to a delivery direction of the foil web, placing the electrolyte membrane between two flow field plates with a gradient in regard to the parameter which is oriented perpendicular to the flow field, and pressing together the flow field plates, wherein at least one of the fuel cells due to its position within the fuel cell stack is provided with a plurality of catalyst pastes, at least one of which differs in regard to a parameter influencing the catalytic activity from the catalyst pastes of the other fuel cells.

10. The fuel cell stack according to claim 9, wherein end fuel cells have property gradients differing from the middle fuel cells.
